(19) United States
(12) Patent Application Publication
(10) Pub. No.: US 2002/0110733 A1
(43) Pub. Date: Aug. 15, 2002

(54) Systems and methods for producing multilayer thin film energy storage devices

(76) Inventor: Lonnie G. Johnson, Atlanta, GA (US)

Correspondence Address: Dorian B. Kennedy, Baker, Donelson, Bearman & Caldwell, Suite 900, Five Concourse Parkway, Atlanta, GA, 30328, US

(21) Appl. No.: 10/119,440

(22) Filed: Apr. 9, 2002

Related U.S. Application Data
(63) Continuation-in-part of application No. 09/633,903, filed on Aug. 7, 2000, now Pat. No. 6,402,796.

(51) Int. Cl. H01M 6/46; H01M 2/18; B23P 19/00; H01M 4/66

(52) U.S. Cl. 429/149; 429/152; 429/162; 429/245; 429/130; 29/730; 29/623.1; 29/623.5; 429/129

(57) ABSTRACT

Systems and methods for producing a multilayer thin film energy storage device having a plurality of thin film battery cells arranged to provide a higher output than a single cell thin film battery. The thin film battery cells are configured so that they stacked one on another with at least one thin film battery cell positioned upside down on top of another thin film battery cell. Alternatively, the thin film battery cells may be arranged in a side-by-side configuration. Each thin film battery cell includes a thin film layer of cathode material and anode material with an electrolyte material disposed between and separating the cathode material and anode material. A thin film current collector is positioned adjacent to each cathode and anode thin film layer. The particular pattern of thin films of current collectors, anodes, electrolytes and cathodes serves to a provide a high output necessary for particular applications. The multilayer energy storage device is produced using an aligning drum system having a web of thin film cells wound therein that allows each thin film layer to be deposited onto a substrate. The output is a sheet containing a plurality of multilayer energy storage devices that can be separated from the sheet to produce an individual multilayer energy storage device. Furthermore, cutting between the stacked layers of multilayer energy storage devices produces individual thin film battery cells.

### RELATED APPLICATION

This is a continuation-in-part of application Ser. No. 09/633,903, entitled “Method of Producing A Thin Film Battery,” filed Aug. 7, 2000, which is incorporated by this reference herein.

### FIELD OF THE INVENTION

This invention relates generally to energy storage devices, and more particularly, to systems and methods for producing multilayer thin film energy storage devices.

### BACKGROUND OF THE INVENTION

Single cell thin film batteries are an evolving technology. This technology involves depositing a thin layer of materials that comprise at least the key components of a thin film battery, an anode, electrolyte and cathode. A number of deposition techniques have been employed to deposit the thin layers including sputtering, evaporation, chemical vapor deposition (CVD), metal organic CVD and plasma enhanced CVD (PECVD). The unique performance features of batteries constructed in this manner provide several advantages in application areas such as medical devices, telecommunications products and electric vehicles. However, it has proven a challenge to commercialize the thin film battery due to costs and problems encountered in the manufacturing process and the difficulties inherent in creating a battery with sufficient capacity to meet demands of these new markets.

Sputtering has been employed most successfully in depositing the thin layer of materials onto each other. Sputtering involves ion bombardment of a target material such as lithium orthophosphate and subsequent release of atoms from the target that in turn deposit on a substrate. This process is effectuated by action of a high voltage on an ionizable gas such as argon under reduced pressure conditions. Momentum is transferred from accelerated ions to target atoms which when released coat the substrate. Reactive sputtering occurs when gas ions are sputtered in a reactive atmosphere such as nitrogen, oxygen, methane or any other gas that contains an element to be incorporated in the thin films that is not already present in the target material. One material produced by the sputtering process is lithium phosphorus oxynitride (LiₓP_{y}ON_{z}) that can be used as an electrolyte. While sputtering produces good adhesion and composition control, sputtering has a low deposition rate when a relatively small number of thin film cells are produced using sputtering techniques.

Cycling involves charging and discharging the thin film battery. One charge and discharge equals one cycle. Batteries used in many applications must be capable of being turned on and off, i.e. cycled, numerous times. Each time the battery is cycled, it is expected that the built in capacity will be reached every time.

A single cell thin film battery has a limited capacity. Many applications such as the ones mentioned previously require relatively high voltages, relatively high currents and relatively high capacities. One way to increase the capacity of the single cell battery is to increase the size of the battery. However, increasing the size of the battery is not desirable where space for the battery is limited in the product or component.

Therefore, a need exists for a thin film battery manufacturing process and configuration that is cost effective to manufacture and produces relatively high voltage, currents and capacity during charge-discharge cycles.

### SUMMARY OF THE INVENTION

This invention includes systems and methods for a multilayer thin film energy storage device having a plurality of thin film battery cells arranged to provide a higher output than a single cell thin film battery. In one embodiment, the thin film battery cells are configured so that they stacked one on another with at least one thin film battery cell positioned upside down on top of another thin film battery cell. This configuration provides the necessary common anode and common cathode configuration between individual cells to achieve the effect of connecting the cells in parallel. In an alternative embodiment, the thin film battery cells are arranged in a side-by-side configuration on a substrate. The thin film battery cells can be stacked to achieve a series or parallel electrical configuration.

Each thin film battery cell includes a thin film layer of cathode material and a layer of anode material with an electrolyte material disposed between and separating the cathode material and anode material. A thin film current collector is positioned adjacent to each cathode and anode thin film layer. A particular pattern of thin films of current collectors, anodes, electrolytes and cathodes serves to provide a high output necessary for particular applications. The base for the multilayer thin film energy storage device can include a substrate made of for instance, metal, ceramic or Kapton. Alternatively, the base for the multilayer thin film energy storage device is the top layer of a previously formed thin film battery cell.

The multilayer thin film energy storage device is produced using an aligning drum system having a web of substrate material wound therein such that allows each thin film layer of the battery can may be deposited thereon. A mask is used to deposit a thin layer in discrete locations on the substrate. In addition, an indexing process provides for further delineation of the location in which the thin film materials will be deposited. Moreover, indexing provides for cutting between a web containing a plurality of multilayer thin film batteries without shorting the batteries.

This invention accordingly aims to achieve at least one, more or combinations of the following objectives:

To provide for a multilayer thin film energy storage device having a higher available energy storage capacity.

To provide methods for producing a multilayer thin film energy storage device.

Other objects, advantages and features of the systems and methods of this invention will be set forth in part in the description which follows and in part will be obvious from the description or may be learned by practice of the invention. The objects, advantages and features of this invention will be realized and attained by means of the elements and combinations particularly pointed out in the claims.

### BRIEF DESCRIPTION OF THE DRAWINGS

FIG. 1 is a cross-sectional view of an embodiment of a multilayer thin film energy storage device having cells connected in parallel.

FIG. 2 is a cross-sectional view of an alternative embodiment of a multilayer thin film energy storage device having cells connected in series.

FIGS. 3A and 3B are flow charts of a process for making the multilayer thin film energy storage device of either FIG. 1 or FIG. 2.

FIG. 4 is a front view of an aligning drum system used in the manufacture of the multilayer thin film energy storage device.

FIGS. 5-13 are top sequential view of the multilayer thin film energy storage device as selected layers of the thin film materials are deposited on a substrate.

FIG. 14 is a perspective view of a web containing a plurality of multilayer thin film energy storage devices that have been separated into individual multilayer thin film energy storage devices.

### DETAIL DESCRIPTION

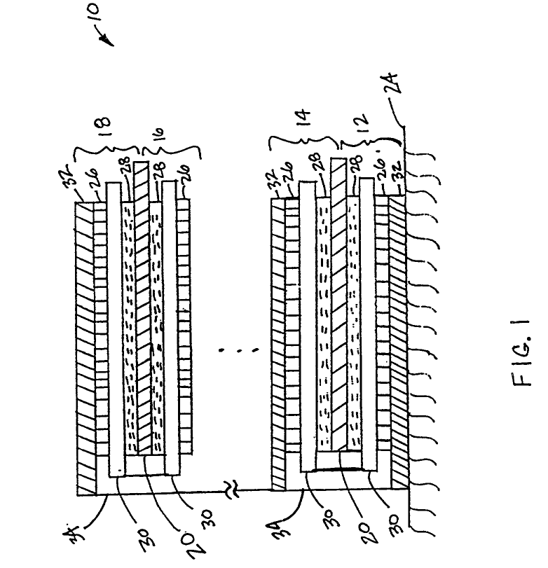

Reference will now be made in detail to preferred embodiments of the invention, examples of which are illustrated in the accompanying drawings. FIGS. 1-13 depict various aspects of a multilayer thin film energy storage device and methods for making the multilayer thin film energy storage device.

FIG. 1 depicts a cross-sectional view of an embodiment of a multilayer thin film energy storage device 10, also referred to as a multilayer thin film battery connected in a parallel arrangement. Generally, the multilayer thin film energy storage device 10 includes a plurality of cells 12, 14, 16 and 18 configured so that they stack one on another with one thin film battery cell positioned upside down on top of another thin film battery cell to form a bipolar configuration. For instance cell 12 is on top of cell 14 and cell 16 is on top of cell 18. Each battery cell i.e. 12 and 14, 16 and 18 shares a common current collector 20, i.e. battery cells 12 and 14 share current collector 20, and battery cells 16 and 18 share current collector 20. While only four battery cells 12, 14, 16 and 18 are shown for illustrative purposes, the multilayer thin film energy storage device 10 is not limited to only four battery cells.

This configuration provides the necessary insulation between each thin film battery. A base for the multilayer thin film energy storage device 10 can include another thin film battery or a substrate 24. A number of materials can serve as substrates, including but not limited to ceramic substrates, flexible substrates and silicon substrates. A suitable ceramic substrate is available from Coors, Clear Creek Valley, 17750 W. 32nd Avenue, P.O. Box 4011, Golden. Colo. 80401, and flexible substrates such as Kapton are available from American Durafilm, 55-T Boynton Road, P.O. Box 6770, Holliston, Md. 01746.

Each thin film battery cell 12, 14, 16 and 18 includes a thin film layer of cathode material 26 and anode material 28 with an electrolyte material 30 disposed between and separating the cathode material 26 and anode material 28. A thin film current collector 32 (also referred to as a cathode current collector) is positioned adjacent to each cathode 26. These layers, the cathode current collector 32, cathode 26, electrolyte 30, anode 28 and current collector 20 (also referred to as an anode current collector) form the basis for one thin film battery 12.

The second or next thin film battery 14 is built on top of the previous thin film battery 12 and shares the anode current collector 20 that serves as the base for this thin film battery 14. The second thin film battery 14 is a mirror image of the thin film battery 12 below beginning with the anode current collector 20. The next layer is the anode 28, followed by layer of electrolyte 30, cathode 26 and cathode current collector 32. To connect the cells 12 and 14 in parallel, an electrically conducting strip 34 connects the cathode current collectors 32. This arrangement of thin film layers provides for a multilayer thin film energy storage device 10. The specific pattern of thin films of current collectors, anodes, electrolytes and cathodes serves to provide a high output necessary for particular applications.

An extended portion of the electrolyte layers 30 is connected together. The thin film current collectors 20, 32 extend beyond the electrolyte such that the current collectors coat and cover the layers below the current collectors. This configuration provides insulation to protect layers below the electrolyte layer so that does not short out.

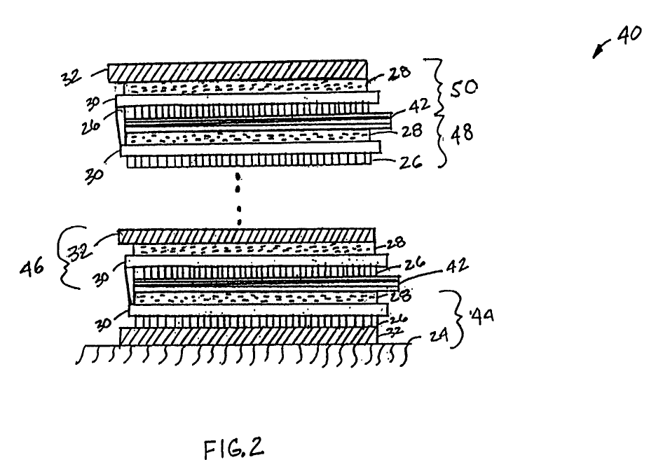

To connect multilayer thin film energy storage devices 40 in series and with reference to FIG. 2, a shared current collector 42 is positioned between cells 44 and 46 and cells 48 and 50. Electrical power can be drawn from the plurality of battery cells 44, 46, 48 and 50.

Each thin film battery cell 44, 46, 48 and 50 includes the thin film layer of cathode material 26 and anode material 28 with the electrolyte material 30 disposed between and separating the cathode material 26 and anode material 28. The base for the first cell typically encompasses a substrate 24. Substrates can include ceramic substrates, flexible substrates and silicon substrates.

The thin film current collectors 32 are positioned adjacent to each cathode material 26 and anode material 28. In a series configuration, the shared current collector 42 positioned between the anode material 28 and cathode material 26 separates one cell from another cell, i.e. separates cell 44 from 46 and cell 48 from 50. This configuration is repeated as needed to add additional cells with a subsequent cell (not shown) beginning with a cathode layer 26 on top of the prior anode current collector 32 that becomes a shared current collector.

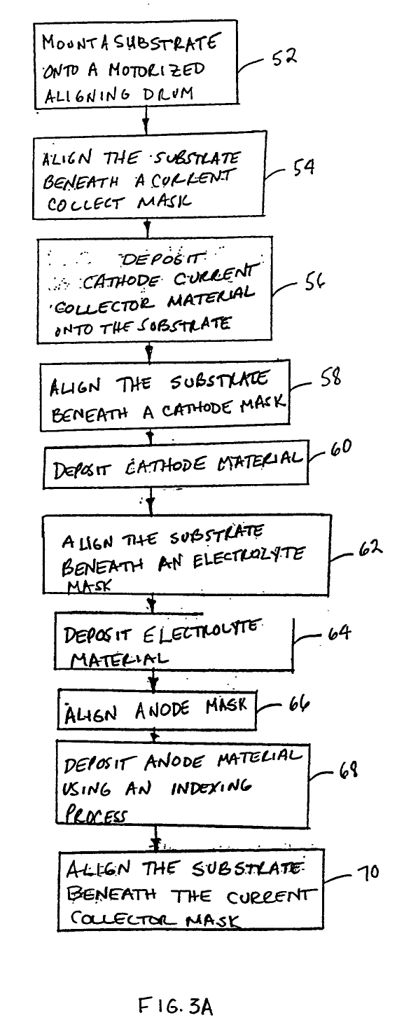

FIGS. 3A and 3B are flow charts of a process for making the multilayer thin film energy storage devices 10, 40 of either FIG. 1 or FIG. 2. At 52, the substrate is mounted onto a motorized aligning drum. In a preferred embodiment, the substrate is placed on a web that moves sequentially to various deposition stations so that a thin film layer of material can be deposited onto the substrate. At 54, the substrate is aligned beneath a current collector mask. Masks serve to allow a material to be deposited at a discrete location on the substrate. At 56, a cathode current collector material is deposited onto the substrate. At 58, the substrate is aligned beneath a cathode mask. At 60, a cathode material is deposited on the substrate. At 62, the substrate is aligned beneath an electrolyte mask. At 64, an electrolyte material is deposited. At 66, an anode mask is aligned. At 68, the anode material is deposited using an indexing process. The drum automatically rotates in discrete incremental steps, stopping in between steps to allow the anode material to be deposited in specific locations.

At 70, the substrate is aligned beneath a current collector mask. At 72, the current collector material is deposited onto the substrate using the indexing process. At 74, the substrate is aligned beneath the anode current collector mask. At 76, the anode material is deposited on the substrate using the indexing process. At 78, the substrate is aligned beneath an electrolyte mask. At 80, the electrolyte material is deposited onto the substrate. At 82, the substrate is aligned beneath a cathode mask. At 84, the cathode material is deposited onto the substrate. At 86, the substrate is aligned beneath a cathode current collector mask. At 88, the cathode current collector material is deposited onto the substrate.

FIG. 4 shows a front perspective view of an aligning drum system 90 used in the manufacturing process to make the multilayer thin film energy storage devices 10, 40 of either FIG. 1 or FIG. 2. A suitable aligning drum system 90 is available from Sigma Technologies International, Inc., 10960 N. Stallard Place, Tucson, Ariz. 85737.

The aligning drum system 90 is configured having an airtight vacuum chamber and includes a motorized drum 92, a motorized unwind reel 94, a motorized rewind reel 96 and load cell reels 98 and 100. The aligning drum system 90 has the capability to deposit materials, for instance by a sputtering process, onto a target, such as a web of material configured to feed across the surface of the drum 92 in a more or less continuous fashion. The aligning drum system 90 may be used as described in related patent application Ser. No. 09/633,903, entitled “Method of Producing A Thin Film Battery,” filed Aug. 7, 2000, which is incorporated by this reference herein.

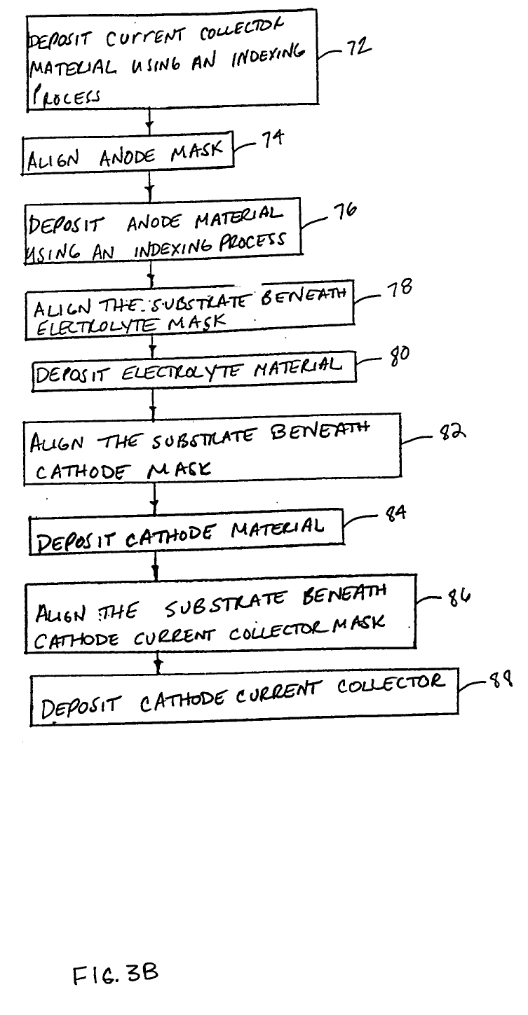

FIGS. 5-13 show tops views of a sequence deposition stations utilized in the manufacture of a multilayer battery. The multilayer battery 10, 14 of either FIG. 1 or FIG. 2 can be produced using the aligning drum system 90 of FIG. 4. The web of material configured to feed across the drum 92 moves to sequential deposition stations as the drum 92 rotates. With reference to FIG. 5, a top view of the substrate 24 having two thin film layers of cathode current collector material 32 deposited thereon. For simplicity, only two layers are shown on the substrate 24. However many more layers may be deposited onto the substrate simultaneously.

FIG. 6 shows the substrate 24 having a cathode material 26 deposited on top of and adjacent to the cathode current collector material 32. A mask (not shown) is used to protect a designated portion of the substrate from receiving a deposit of material. In FIG. 6, the mask protects a designated portion of the cathode current collector 32 from having cathode material 26 deposited thereon.

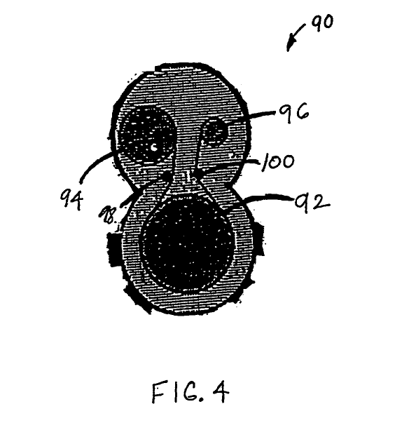

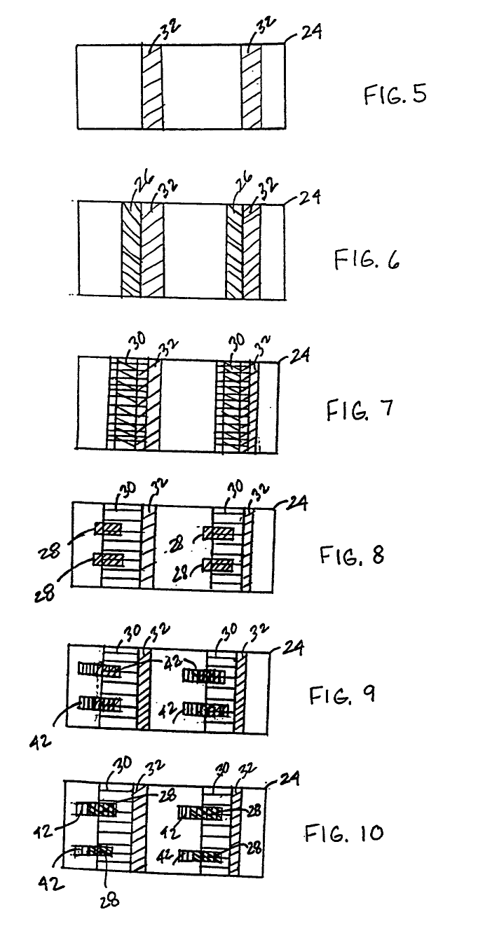

FIG. 7 shows the next layer deposited onto the substrate 24. The electrolyte material 30 is deposited onto the cathode material layer 26 and covers a selected portion of the cathode current collector material 32. A mask (not shown) is used to achieve the proper distribution of electrolyte material 30. As illustrated, to this point, the cathode current collector material 32, cathode material layer 26 and electrolyte material 30 can be deposited in more or less continuous strips along the substrate web as it moves across the rotating drum 92. The entire web may be coated with one material, reversed and coated with a follow on material. The web may even be moved to totally separate deposition chambers for follow on deposition chambers. It is often advantageous to not deposit different types of materials simultaneously in a single deposition chamber.

FIG. 8 shows the substrate 24 having an anode material 28 deposited on the electrolyte material 30. The anode material 28 is deposited using the indexing process described in FIG. 3A. Generally, the indexing process involves masking the substrate 24, turning on the sputtering cathode drum 92, depositing the anode material 28, turning off the sputtering cathode drum 92 and turning the aligning drum a step or cycle.

FIG. 9 shows the substrate 24 having a shared current collector 42 deposited on the electrolyte material 30. After masking, the shared current collector 42 is deposited using the indexing process described above.

FIG. 10 shows a layer of the anode material 28 deposited on the anode current collector 42. After masking, the anode material 28 is deposited over a portion of the current collector 42 using the indexing process described above.

FIG. 11 shows a layer of electrolyte material 30 deposited onto the existing layers in a position substantially similar to the prior layer of electrolyte material 30. The electrolyte material 30 covers a selected portion of the cathode current collector material 32. A mask (not shown) is used to achieve the proper distribution of electrolyte material 30.

FIG. 12 shows a layer of cathode material 26 deposited onto the electrolyte material 30 substantially in the same manner as the prior layer of cathode material 26. A mask (not shown) is used to protect a designated portion of the existing layers so that the cathode material 26 can be deposited on a selected portion of the substrate 24.

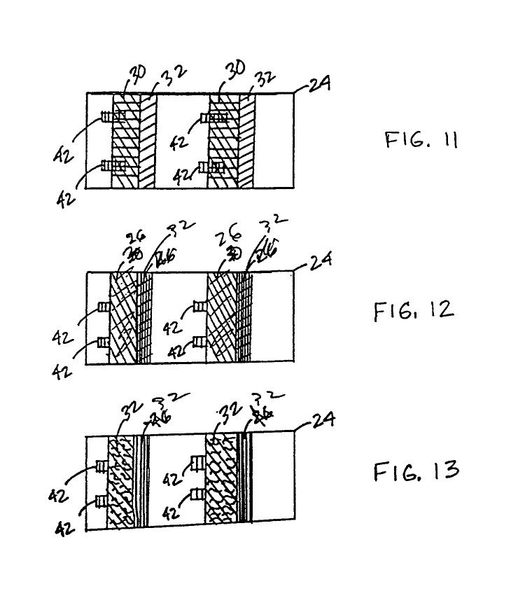

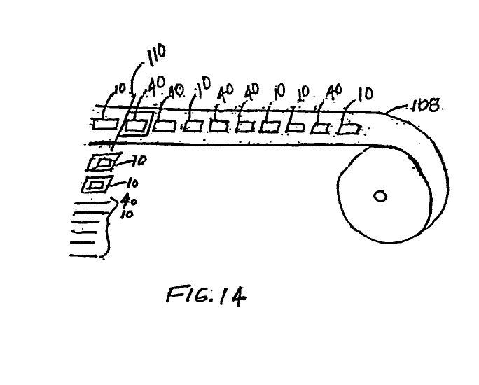

FIG. 13 shows the cathode current collector material 32 selectively deposited over the prior layers. The cathode current collector material 32 is deposited adjacent to and covers a portion of the cathode material 26 as prior current collector layers 32.

In the multilayer battery, the shared current collector has an anode layer deposited thereon. An electrolyte layer is deposited upon the anode layer. A cathode layer is deposited upon the electrolyte layer and a cathode current collector layer is deposited upon the cathode layer. These layers are achieved by repeating the processes outlined in FIGS. 3A and 3B and the system described in FIGS. 5 through 13.

A protective coating may then be deposited in any conventional manner upon the final layer of the battery to be deposited. A suitable protective coating is described in U.S. patent application entitled, “Packaging Systems and Methods for Thin Film Solid State Batteries,” Ser. No. 09/733,285, filed Dec. 8, 2000 and is incorporated by this reference herein.

The manufacturing process described above provides for multilayer cells produced on a continuous sheet or web. The multilayer cells can be separated into individual batteries through a cutting process whereby the web can be cut without damaging the cells. FIG. 14 is a perspective view of a web 108 containing a plurality of multilayer thin film energy storage 10 or 40 devices that have been separated into individual multilayer thin film energy storage devices. For simplicity, only one row of multilayer thin film energy storage devices is shown on the sheet however, more than one multilayer thin film energy storage device can be produced on the sheet and cut from the sheet. A cutting device 110 can be used to cut around the cells to provide individual batteries. The indexing provides for cutting between the web 108 without shorting the batteries.

The indexing and masking method described for deposition of anodes and anode current collectors allow the batteries to be cut away from the continuous web without damaging or shorting individual cells. An alternative approach would be to individually mask the cathodes and cathode current collectors to allow cutting away the individual cells without damage.

An advantage of this invention is that multilayer batteries can achieve higher voltages and/or higher capacities and currents than a single layer battery.

Another advantage of this invention is that the process to manufacture the multilayer battery is more efficient and effective using the aligning drum system.

Still another advantage of this invention is that the indexing process provides for cutting between a web containing a plurality of multilayer thin film batteries without shorting the batteries.

The foregoing is provided for purposes of illustrating, explaining and describing several embodiments of this invention. Modifications and adaptations to these embodiments will be apparent to those of ordinary skill in the art and may be made without departing from the scope or spirit of the invention and the following claims. For instance, the multilayer battery can be produced by a variety of systems including using sputtering processes independent or in conjunction with the aligning drum system to produce the multilayer battery. Also, the embodiments described in this document in no way limit the scope of the below claims as persons skilled in this art recognize that this invention can be easily modified for use to provide additional functionalities and for new applications.

Although the invention is disclosed based on use of sputtering deposition techniques, other deposition techniques are also applicable including for instance, chemical vapor deposition (CVD), metal organic chemical vapor deposition (MOCVD), combustion chemical vapor deposition (CCVD), plasma enhanced chemical vapor deposition (PECVD), evaporation physical deposition and electron beam evaporation deposition.

I claim:

1. A multilayer thin film battery, comprising:
at least two thin film battery cells each having deposited thin film layers of a cathode material, an electrolyte material adjacent to the cathode material, an anode material adjacent to the electrolyte material and an anode current collector material adjacent to the anode material, the thin film battery cells are arranged in a stacked configuration such that one thin film battery is positioned directly on top of another thin film battery in an upside-down orientation with the thin film battery cells sharing the anode current collector material.

2. The multilayer thin film battery of claim 1, wherein each thin film battery cell further comprises a thin film cathode current collector material deposited adjacent to the cathode material.

3. The multilayer thin film battery of claim 2, wherein each thin film battery cell further comprises a substrate adjacent to the cathode current collector material.

4. The multilayer thin film battery of claim 3, wherein the substrate is selected from the group consisting of:
a. ceramic;
b. kapton;
c. stainless steel; and
d. a layer of the cathode current collector material from another thin film battery cell.

5. The multilayer thin film battery of claim 2, further comprises an electrically conducting strip connecting the cathode current collector materials.

6. The multilayer thin film battery of claim 2, wherein the thin film battery cells are configured in a series relationship.

7. The multilayer thin film battery of claim 2, wherein the thin film battery cells are configured in a parallel relationship.

8. The multilayer thin film battery of claim 2, wherein the electrolyte material further comprises an extended portion for connecting the electrolytes together.

9. The multiplayer thin film battery of claim 1, wherein the deposited thin film layers are deposited using a deposition process selected from the group consisting of:
a. sputtering deposition;
b. chemical vapor deposition;
c. metalorganic chemical vapor deposition;
d. combustion chemical vapor deposition;
e. plasma enhanced chemical vapor deposition;
f. evaporation physical deposition; and
g. electron beam evaporation deposition.

10. A system for separating multilayer thin film energy storage devices produced by a continuous web process, comprising:
a. a sheet having a plurality of multilayer thin film energy storage devices thereon; and
b. a cutting device connected to the continuous web process, the cutting device adapted to cut and separate each multilayer thin film energy storage device from the sheet.

11. A method for separating multilayer thin film energy storage devices, comprising:
a. producing from a continuous feed a sheet having a plurality of the multilayer thin film energy storage devices; and
b. cutting the sheet to separate the plurality of multilayer thin film energy storage devices into an individual multilayer thin film energy storage device.

12. The method of claim 11, further comprises:
c. stacking the individual multilayer thin film energy storage devices for packaging and shipping.

13. The method of claim 11, wherein the cutting the sheet to separate the plurality of multilayer thin film energy storage devices into an individual multilayer thin film energy storage device step further comprises cutting around the individual multilayer thin film energy storage device to provide individual multilayer cells.

14. A method of manufacturing a multilayer thin film battery, comprising:
a. mounting a substrate and aligning the substrate beneath a current collector mask;
b. depositing a current collector material onto the substrate;
c. aligning the substrate beneath a cathode mask;
d. depositing a cathode layer upon selected portions of the current collector material;
e. aligning the substrate beneath an electrolyte mask;
f. depositing an electrolyte material upon selected portions of the cathode layer;
g. aligning the substrate beneath an anode mask;
h. depositing an anode material onto selected portions of the electrolyte material using an indexing process;
i. aligning the substrate beneath an anode current collector mask; and
j. depositing an anode current collector layer on selected portion of the anode material using an indexing process.

15. The method of claim 14, further comprises:
a. repeating steps c-j until the desired number of battery cells has been completed.

16. The method of claim 15, further comprises:
a. producing from a continuous feed a sheet having a plurality of multilayer thin film batteries thereon;
b. cutting the sheet to separate the plurality of multilayer thin film batteries into individual multilayer thin film batteries; and
c. stacking the individual multilayer thin film batteries into layers for packaging and shipping.

17. The method of claim 16, wherein the cutting the sheet to separate the plurality of multilayer thin film batteries into individual multilayer thin film batteries further comprises cutting around and between the multilayer thin film batteries with a cutting device to provide individual multilayer cells.

18. The method of claim 15, further comprises depositing a protective layer over the completed multilayer thin film battery.

19. The method of claim 14, wherein the depositing of steps b, d, f, h and j is performed using a deposition technique selected from the group consisting of:
a. sputtering deposition;
b. chemical vapor deposition;
c. metalorganic chemical vapor deposition;
d. combustion chemical vapor deposition;
e. plasma enhanced chemical vapor deposition;
f. evaporation physical deposition; and
g. electron beam evaporation deposition.

20. The method of claim 15, wherein the indexing process further comprises masking the substrate, turning on a sputtering drum system, depositing selected material, turning off the sputtering drum system and turning the sputtering drum system one cycle.
